(19) United States
(12) Patent Application Publication
(10) Pub. No.: US 2014/0172478 A1
(43) Pub. Date: Jun. 19, 2014

(54) METHODS AND SYSTEM FOR AUTOMATIC WORK LOGGING AND TRACKING

(71) Applicant: Attila Vadasz, Budapest (HU)

(72) Inventor: Attila Vadasz, Budapest (HU)

(73) Assignee: TCT Hungqary Kft.

(21) Appl. No.: 13/713,026

(22) Filed: Dec. 13, 2012

(51) Int. Cl. G06Q 10/06

(52) U.S. Cl. CPC G06Q 10/063114
USPC 705/7.15

(57) ABSTRACT

A computer system for automated work logging having a processor, an automatic data capture module for capturing computer usage data, a task list having one or more tasks, a task matching unit which is configured and arranged to match a task in the task list to the computer usage data, and a work log data storage for storing matched computer usage data.

### TECHNICAL FIELD

The present invention relates generally to the field of employee work time tracking, and more specifically to computer related work automatic time tracking.

### BACKGROUND ART

Several software applications are known for tracking time spent by employees working on tasks. For example, the system at transparentbusiness.com is directed to a system of tracking work hours involving worker self assessment. International patent application WO 2009/108880 is directed to a human-computer productivity management system for monitoring the interactions between humans and computers. U.S. Pat. No. 7,941,439 is directed to systems and methods for information capture including keystroke processing and event creation.

### BRIEF SUMMARY OF THE INVENTION

With parenthetical reference to the corresponding parts, portions or surfaces of the disclosed embodiment, merely for the purposes of illustration and not by way of limitation, provided is a computer system (100) for automated work logging having: a processor (101); an automatic data capture module (125) for capturing computer usage data (123); a task list (127) having one or more tasks; a task classifier/matching unit (124), the task classifier/matching unit configured and arranged to match a task in the task list to the computer usage data; and a work log data storage (133) for storing matched computer usage data. The automatic data capture module may be configured and arranged to capture data using an algorithm. The algorithm may be an event based algorithm. The algorithm may be a time based algorithm. The task classifier may be configured and arranged to match a task with manual interaction.

The computer system may further have a data review module (136) for allowing a data reviewer (17) to view a contents of the work log data storage. The computer system may further have a user interface (130) for allowing a user (110) to manually enter a task into the task list (127). The automatic task classifier may be configured and arranged to insert (103) a new task in the task list when a task matching the computer usage data may be not in the task list.

In another aspect, provided is a method (200) of monitoring a computer system having the steps of: providing (203) a computer system (100) having a processor (101); capturing (206) computer usage data (123); matching (209) the computer usage data to a task from a task list (127); tagging (212) the computer usage data with the matched task; storing (215) the tagged computer usage data in a data storage (133); generating (218) work log data of a total amount of time spent on each task within the task list based upon the tagged computer usage data.

In yet another aspect a method (300) of monitoring a computer system (100) having the steps of: providing (303) a computer system (100) having a processor (101); capturing (306) computer usage data (123); storing (309) the data in a data storage (133); and analyzing (315) the computer usage data to verify that the data represents valid work. The step of analyzing may be performed by a computer algorithm. The step of analyzing may be performed by human analyzer.

In another aspect an information display system (400) is provided having: a computer system having a processor and a data storage; in which the data storage configured and arranged to store a list of task identifiers; and the computer system is configured and arranged for event triggered measurement of a work time and the computer system may be configured and arranged to match the work time to a task identifier in the list; and a computer display (480) configured and arranged to show a graphic object (483, 485, 487) corresponding to each task identifier, each the graphic object having a first property which may be a function of the captured work time matched to each task identifier. The event may be a mouse activity, a keyboard activity, a time duration, an operating system event, a software event/interrupt, or a human interface device event. The computer system may be further configured to both start and stop a data capture based upon events. A time estimate may be associated with each task identifier. The function of the captured work time may be a calculation of an estimated time, a time consumed, a percent complete, an inner cost, a priority, a deadline, an amount over/under deadline, an amount over an estimate, a remaining work to be done, a proportion of hours already spent on the task, a time since project start, an average number of late days, or an average number of extra hours that were worked on a task over estimate. The first property may be a fill color, a border color, a size, or a shape. Each the object may have a second property which may be a function of the captured work time matched to each task identifier. Each the object may have a third property which may be a function of the captured work time matched to each task identifier.

In another aspect, provided is a method of displaying information (500), having the steps of: providing (503) a computer system having a processor; defining (506) a list of tasks; estimating (509) a first property for each task in the list; capturing (512) work data with the computer system; providing (515) a computer display; and displaying (518) information on the computer display as a function of the captured work data and the estimated property. The step of capturing work data may be an event based capture of work data. The step of capturing work data may be a time based capture of work data. The first property may be a total time estimate. The first property may be a total cost estimate, or a deadline. The method may further including the step of assigning a priority to each task in the list. The method may further include the step of assigning a competence level to each task in the list.

The methods may further include the step of providing a list of individuals with a competence level for each individual. The methods may further include the step of providing an availability level for each individual may be the list of individuals. The methods may further include the step of providing a work history for each individual may be the list of individuals. The methods may further include the step of further assigning individuals to a task as a function of task properties or individual properties.

The methods may further the step of determining whether an employee was performing within a set of pre-established rules. The methods may further have the step of penalizing an employee who does not perform within a set of pre-established parameters, rules, laws, requirements, or decrees. The parameters may consist of a core time, a total work time, an obligation to work on particular tasks, a work time vs total time ratio, a work time by PC, an active computer work time, a count of computer inactivities longer than a time duration, a work time for a given location, a work time via telephone, a manually added work time amount, a work start time, a work stop time, a count of late work start times, a count of early work stop times, a count of core work time violations, a work time deficit/surplus, a count of work incidents, or a function of the listed parameters.

The methods may have the step of generating reports. The reports may be based upon the stored work log data associated with a given employee. The reports may be based upon the stored work log data associated with a set of tasks. The methods may further have the step of generating an employee performance rating. The step of generating an employee performance rating may be a function of how many times an employee was late, the total number of hours worked by an employee, the frequency of tasks completed on time, the adherence of an employee to stated rules, laws, requirements, or decrees, a rate of inactivity, a number of times a closed task may have to be reopened, a time estimate accuracy, a level of matching time estimates, a frequency of meeting deadlines, a frequency of working on task with a highest priority, or a function of all the listed parameters.

The step of analyzing in the above methods may include the step of reviewing display screenshots. The step of analyzing may include the step of reviewing keyboard activity, mouse activity, display screenshot wireframes, window metadata, camera data, windows names, URLS, geographic position, location data, or a function of all listed parameters. The step of matching may include the step of comparing the computer usage data to a text string associated with a task in the task list. The step of matching the computer usage data may include the step of generating a new task when none of the tasks in a task list match the computer usage data. The methods may further have the step of manually adding tasks to the task list.

In each of the stated methods and systems, the computer usage data may further include display screenshots, mouse activity, keyboard activity, visible window names, or URL's visited by a browser. The computer usage data may include a wireframe screenshot. The computer usage data may include a display window metadata. The computer usage data may be captured/recorded based upon a window metadata. The computer usage data may include a geographic location, a phone number, a camera image data, or user interface input.

The geographic location may be a GPS data, a IP network data, or a cell tower information. The camera image data may be analyzed. The computer usage data further may include radio frequency id or near field communication data.

The step of capturing computer usage data may include the step of performing optical character recognition on a display screenshot and the computer usage data may include a text string generated from the optical character recognition step. The step of matching may include the step of comparing graphical data in the captured computer usage data to graphical data associated with a given task.

The methods may further have the step of providing a computer user interface for allowing a user to choose a task to be associated with the computer usage data. The methods may further have the step of providing a computer user interface for allowing a user to turn data capture on/off. The methods may further have the step of providing a computer user interface for reviewing the work log data from a remote computer. The methods may further have the step of limiting access to the work log data through the user interface as a function of an access level. The access level may include a level for an employee, a group manager, a subscriber, a verification manager, a registrant, or a customer. The tasks in the task list may have an associated window name string. The tasks in the task list may have an associated application name string. The tasks in the task list may have an geographic location. The tasks in the task list have a parameter associated with a URL, phone number, process id, file location, or a working directory.

The methods may further have the step of transmitting the tagged computer usage data to a remote server computer over a computer network. The methods may further have the step of storing the transmitted tagged data into a server computer database. The methods may further have the step of providing a subset of the tagged computer data to a human operator for manual review. The subset may include data from a randomly selected workday. The methods may further have the step of providing a subset of the tagged computer data to a computer system for automatic review. The methods may further have the step of generating an alert when the computer data does not match a valid work condition. The step of matching the computer usage data may be done on server computer. The step of capturing computer usage data may be stopped after a period of computer inactivity. The step of capturing computer usage data may be stopped after a period of computer inactivity only outside of a core work time period during the day. The captured computer usage data may be masked in order to hide sensitive data.

The methods may further have the step of providing an application program interface for receiving task or work log data or transmitting task or work log data. The interface may be established with a PM, CRM, ERP, or back-office system. The methods may further have the step of encrypting the computer usage data. The methods may further have the step of automatic payment to a worker based upon the work log or computer usage data. The methods may further have the step of automatically billing a customer based upon the work log or computer usage data. The methods may further have the step of prioritizing the tasks in the task list. The tasks may be prioritized based upon deadline, hours remaining until completion, or a user assigned priority. The priority of tasks may be displayed over a user interface. A next task to be completed may be selected based upon automatic rules.

The methods may further have the step of providing an interface for receiving meeting data from a calendar application, and adding work log data for a user when the user may be shown to be in a meeting. The step of capturing computer usage data may include automatic rules for deciding when to start or stop capturing data. The automatic rules include starting or stopping data capture based upon a geographic location, an application name, a phone call duration, or a function of the computer usage data. The automatic rules are configured to count a travel time as work time when a destination may be a work destination. The automatic rules are configured to count a travel time as work time when a travel path may be a work travel path.

The methods may further have step of capturing computer usage data may include capturing keystroke log data. The methods may further have step of performing a text search of the keystroke log data and sorting the computer usage data based upon the text search.

The methods may further have the step of compressing the computer usage data. The methods may further have the step of providing a user incentives. The incentives may include monetary incentives, extra work breaks, extra vacation time, or the ability to leave work early. The methods may further have the step of calculating a user fatigue. The methods may further have the step of providing a user a work break when user fatigue may be identified.

The methods may further have the step of providing a data backup function for recovering recorded keystrokes when a user file may be accidentally deleted or corrupted. The methods may further have the step of creating a Gantt chart based upon the captured computer usage data.

The methods may further have the step of periodically querying a user whether he or she may be still be working when a level of inactivity is identified.

The methods may further have the step of analyzing the computer usage data for detection of malware activity.

In the methods and systems identified, the computer usage data may include an audio recording of a phone conversation. The methods may further have the step of converting speech to text.

### BRIEF DESCRIPTION OF THE DRAWINGS

FIG. 1 is a system block diagram of a first embodiment system.

FIG. 2 is a flowchart of a first embodiment method.

FIG. 3 is a flowchart of a second embodiment method.

FIG. 4 is a view of an information display.

FIG. 5. is a flowchart of a third embodiment method.

FIG. 6 is a system block diagram of a second embodiment system.

FIG. 7 is a block diagram of a general version client application shown in FIG. 6.

FIG. 8 is a first form of client application shown in FIG. 7.

FIG. 9 is a second form of client application shown in FIG. 7.

### DETAILED DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

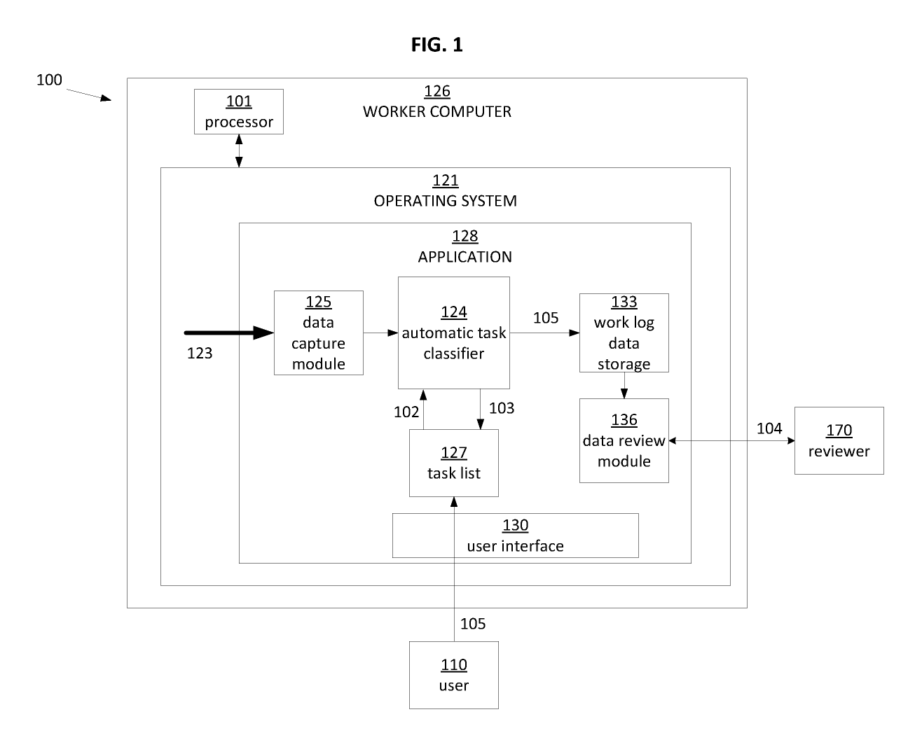

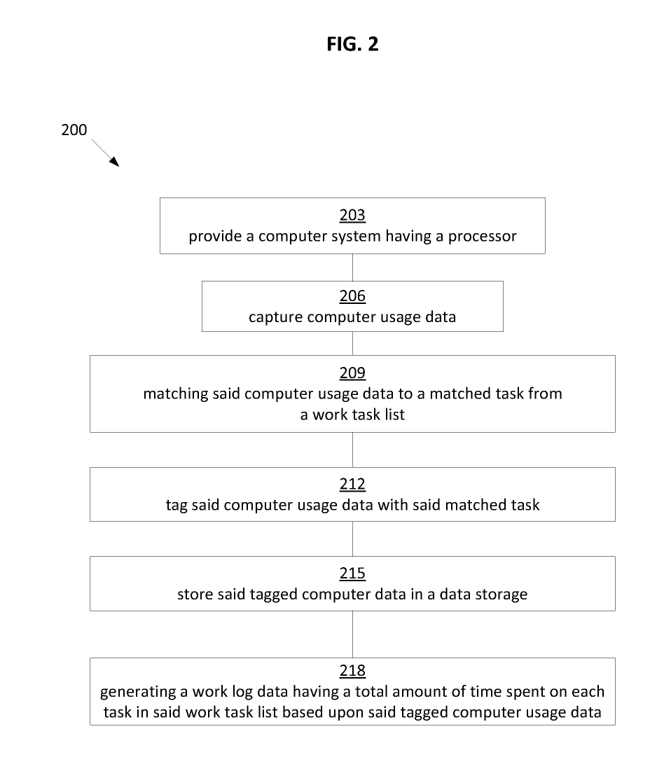

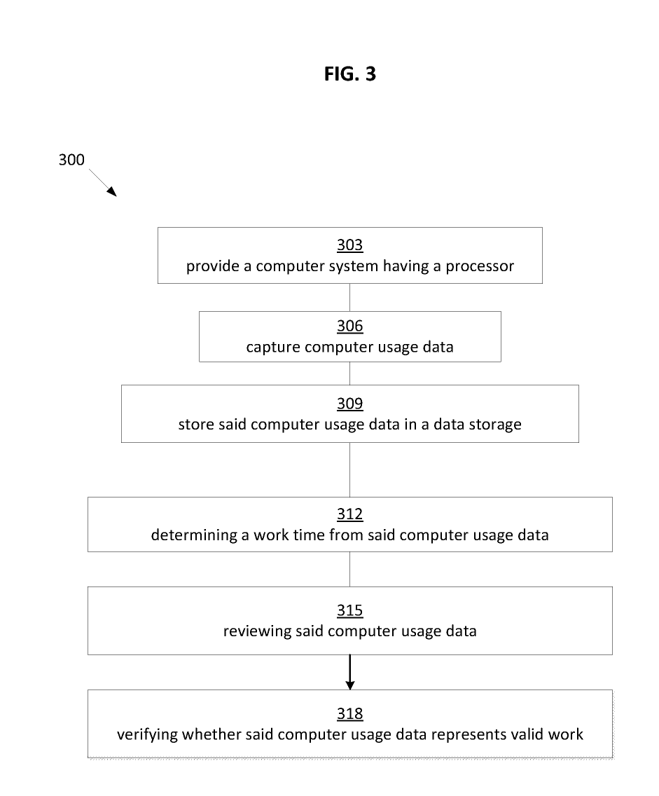

Referring now to the drawings, and more particularly to FIG. 1, the disclosed embodiments provide a method and system for automatic work logging and review, a first embodiment system of which is shown at 100. FIGS. 2 and 3 represent flowcharts of methods of automatic work logging associated with the system shown in FIG. 1. System 100 is directed to a system for allowing a worker to automatically track, classify, and/or verify the work time of one or more employees. A set of work classifications or work tasks/jobs are created automatically and/or optionally with human interaction. As computer usage data is automatically captured, it may be automatically classified into a matching task, or, if no matching task is found, a new task may be generated. The computer usage data is then converted into a work log data entry which will optionally indicate the task worked on and/or the duration of time that was worked on that particular task. A subset of the computer usage data and the work log data entry may optionally be transmitted and displayed to a human reviewer who verifies that the computer usage data appears to match the indicated work log.

System 100 consists of the major components of worker computer 126 which has processor 101 and operating system 121. Software application 128 is installed on worker computer 126 and includes data capture module 125, work log data storage 133, and optionally includes user interface 130, automatic task classifier 124, and/or data review module 136.

Processor 101 is implemented as a central processing unit, microprocessor, microcontroller, application specific integrated circuit, field programmable gate array, or other similar logic device. A computer memory is coupled to processor 101 and is implemented either directly in processor 101, or as a separate memory device, such as an dynamic ram, static ram, flash memory, hard drive, and/or other similar memory device. Operating system 121 may be a simple while loop, or any operating system such as Windows, MacOS, Linux, unix, Android, IOS, or other similar operating system. Application 128 may be implemented as a standard desktop computer application, a smartphone/tablet app, or any other similar application type.

Application 128 includes data capture module 125 which is configured to automatically capture computer usage data 123. Computer usage data 123 includes any computer activity including computer user interaction information; active and idle computer process information; computer resource utilization information including network usage, processor utilization, file system, display, and/or memory utilization; and/or other similar information. Computer user interaction data may include keyboard, keystroke, touchscreen, mouse, touchpad, microphone, camera, display, open/closed/active/idle window, process, application, name, id, network address, URL, phone activity, phone numbers, and/or any other similar computer user interface data. Other computer usage data may further include graphical screenshots, or extracted graphical features of a computer graphical display. The computer usage data may include both raw data (such as raw keystroke data) and/or extracted activity rates (such as keystrokes per second). The computer usage data may include window metadata, which may include a window coordinate, a window size, and a window active/background flag. The graphical computer usage data similarly may be raw screenshot data, or may be extracted data, such as wireframe data of open windows. The data extraction may be tailored to reduce the size of the total data captured and/or may be tailored to maintain a level of privacy/secrecy of the work being performed. Text strings may be extracted from the graphical data, such as an account number from a window screenshot, and may be implemented using an optical character recognition module. In this way, the complete screenshot does not need to be saved, reducing storage requirements and allowing private data which may be visible on the screen to not be captured. Other computer usage data may be the filenames of files opened/closed/saved or may be location tracking information, such as GPS data, or local network data. Additionally, computer usage data may include form data submitted to/from a smartphone app or web application. Computer usage data also should include a time stamp or time identifier which would allow a calculation of work time. The time stamp may simply be a record of the time when the computer usage data was collected.

Data capture module 125 may be configured to periodically capture data, such as once every 30 seconds, and/or may be configured to capture data when triggered by operating system hooks, such as when a key is depressed or a mouse moved. The data capture module 125 passes captured computer usage data to the optional automatic task classifier 124.

Automatic task classifier 124 maintains task list 127, which is configured to hold a list of task identifiers. A user 110 may manually create entries into task list 127 through user interface 130. User interface 130 may be a text console, graphical interface, or other similar interface. Task list entries may be automatically generated by automatic task classifier 124. Task list identifiers may be a text string, an application name, a filename, a process name, a numerical ID, a phone number, and/or any informational identifier that can be obtained as a function of the captured computer usage data or direct user interaction. For example, a task identifier may be a task representing Microsoft Access usage, and may have the specific task identifier “Microsoft Word”. As another example, the task identifier may represent work performed on a project involving software development for Acme corp. and may have the specific task identifier string “acme software development”. Automatic task classifier 124 is configured to read task list 127 and try to match captured computer usage data 123 to a particular task identifier in task list 127. More specifically, task list tries to match the task identifiers as a function of captured computer usage data 123. If a match is found, computer usage data 123 is tagged with the task identifier and is stored in work log data storage 133. If captured computer usage data 123 cannot be matched to an entry in task list 127, automatic task classifier may create and insert a new task into task list 127, with a task identifier obtained as a function of captured computer usage data 123. In this case, captured computer usage data is tagged with the new task and is then inserted into work log data storage 133.

Several functions may be used in determining whether a task list entry matches computer usage data. The matching step may be a straight forward text comparison between a portion of the captured computer usage data and the task identifier. For example, the active application may be extracted in a string format from computer usage data 125 and compared to a task identifier string. For example, if the active application in computer usage data 123 is Microsoft Word, the name “WORD” may be extracted from the computer usage data and a task list entry with the task identifier string “Microsoft Word” may be matched. Similarly, a phone number that was called may be extracted to from the computer usage data and compared to a phone number stored in a task identifier. Text string comparisons may be used with the application name, the active window, the background windows, the URL's visited, etc.

The matching function may also involve more complex comparisons. For example, as stated earlier, the computer usage data may involve extracting an account number from a graphical screenshot of a given window. This extracted account number could be matched with a particular task which has the same account number specified in the task identifier. As a further example, the open window dimensions and/or total screen percentages may be used to match data. More specifically, if the active window is “Microsoft Word”, but the background window for “Media Player” takes up 75% of the total screen, automatic task classifier may match the computer usage data to a “Move Player” task instead of a “Microsoft Word” task, since it would appear that a user may be watching a movie instead of actually working on a Word document. However, if the background “Media Player” window takes up only 5% of the screen, then the computer usage data may be matched to the “Microsoft Word” task, since it appears that the user may be merely playing the radio in the background. Other functions for matching include looking at keypress frequencies, in order to distinguish typing in a document and playing a video game. Location data may be used to match a task as well. For example, GPS coordinates may be used to identify the task of visiting a customer/vendor at a given location. Similarly, identification of GPS data that is not on a defined track may identify when an employee has deviated from a defined work travel path and is not working on a work task.

When matched/tagged computer usage data is stored in work log data storage 133, a calculation is made of the amount of time that is spent working. For example, time stamps of computer usage data may be summed for a given task in order to determine a total work time associated with a given task. Work log data storage 133 may be a database, such as a MySQL, Microsoft SQL, Oracle DB, or other similar database. Alternatively, data storage 133 may be a simple file storage.

Optional data review module 126 provides an interface for allowing reviewer 170 to view information in work log data storage 133. The interface may provide only a subset of the computer usage information. For example, the interface may only provide a screenshot portion of computer usage data 123. Alternatively, the interface may provide only a wireframe view of open windows extracted from screenshots. Reviewer 170 observes the data over the interface in order to make a determination of whether the observed data appear to correctly be matched with the matched identifier task. The interface provided by 136 allows reviewer 170 to identify whether the data appears to be correctly matched. For example, if a screenshot shows that a movie is being watched in a background window, but the data was matched to the task of working on a Microsoft word document, reviewer 170 may identify the data as incorrectly classified/matched.

FIG. 2 displays a flow chart of first embodiment method 200 of automatic work logging/tracking which may be performed using system 100. Method 200 begins with step 203 of providing a computer system having a processor. The computer system may be similar to system 100 shown in FIG. 1 and described above, or may be a separate computer system. Step 203 is followed by step 206, capturing computer usage data. Capturing computer usage data includes identifying any interaction a user may have with a computer system and/or extracting any subset of such interaction data. Computer usage data may include human interface device information such as activity on a keyboard, mouse, touchpad, touchscreen, keypad, accelerometer, gyroscope, microphone, speaker, camera, and/or graphical display information including screenshots. The computer usage data may also include location data, phone system data, network data such as IP addresses, phone numbers, or URLs, active/open window names, active/background process names, active/background application names, open/saved filenames, and/or form data. The computer usage data may also include data that is extracted from other data, such as text strings extracted from screenshots through optical character recognition, or keyboard activity levels from keystroke data. Step 209 includes matching the captured computer usage data to a task in a work task list. The work task list is a list of work tasks that are either created a priori by a user, or are dynamically created by system 100. Matching includes comparing a function of the captured computer usage data to a function of the tasks in the task list. For example, the matching function may be performing a text string comparison between computer usage data and a task identifier. The text string may be an application name, window name, process name, phone number, file name, or any other similar text string associated with computer usage data. Alternatively, the matching function includes calculating characteristics of graphical data in the computer usage data, such as calculating a window percentage and matching a task based upon the calculated window percentages. The matching function may further include performing an optical character recognition of the computer usage data, or a graphical comparison between screenshot data and a graphical icon associated with a task. The matching function may further be a function of location data, such as GPS coordinates. A distance comparison may be conducted between a location identified with a task and the location identified from computer usage data. Step 209 may further include the step of creating a new task in the task list if an appropriate task cannot be matched to the computer usage data.

Step 209 is followed by step 212, tagging the computer usage data with the matched task. Tagging the data may involve coupling a task identifier text string or ID number to a data record linking the captured data storage and the matched task. Step 215 includes storing the tagged data in a data storage. The data storage may be a database or a file. Method 200 concludes with step 218, in which work log data is generated. The work log data includes information representing the total amount of time spent on each task listed in the task list. This data may be generated by summing the total number of data records tagged with a given task in the data storage. Alternatively, the data may be generated by summing a timestamp associated with each data record tagged with a given task identifier.

FIG. 3 is a flowchart for a second method 300 of automatic work logging/tracking. Method 300 is generally similar to method 200, however, involves the step of reviewing computer usage data for validity/accuracy. More specifically, method 300 begins with step 303, providing a computer system having a processor. The computer system may be any basic computer system, such as a desktop computer, notebook computer, phone, smartphone, personal data assistant, watch, tablet computer, or any other similar computer. The processor may be implemented as a microprocessor, microcontroller, CPU, FPGA, ASIC, programmable logic device, or other similar controller. Step 306 includes capturing computer usage data performed on the computer system provided. Computer usage data generally includes any information relating to a user's interaction with the computer, and may include human interface device information such as activity on a keyboard, mouse, touchpad, touchscreen, keypad, accelerometer, gyroscope, microphone, speaker, camera, and/or graphical display information including screenshots. The computer usage data may also include location data, phone system data, network data such as IP addresses, phone numbers, or URLs, active/open window names, active/background process names, active/background application names, open/saved filenames, and/or form data. The computer usage data may also include data that is extracted from other data, such as text strings extracted from screenshots through optical character recognition, or keyboard activity levels from keystroke data. Step 309 is storing the computer usage data in a data storage. The data storage may or may not be part of the computer system provided. More specifically, data storage may be located on a server computer which is separate from the computer system provided. Step 312 includes determining a work time form the computer usage data. The step of determining a work time may include summing a number of computer usage data logs created, or by summing the differences between timestamps identifying when computer usage started and finished. Step 315 includes reviewing the computer usage data, and step 318 is verifying whether the computer usage data represents valid work. For example, step 315 may be implemented by providing a reviewer a subset of the computer usage data, such as screenshots. Step 318 may represent the step of the reviewer determines whether the screenshot appears to be work related. For example, if the screenshot appears to represent a movie playing, a reviewer may determine that the data does not represent valid work.

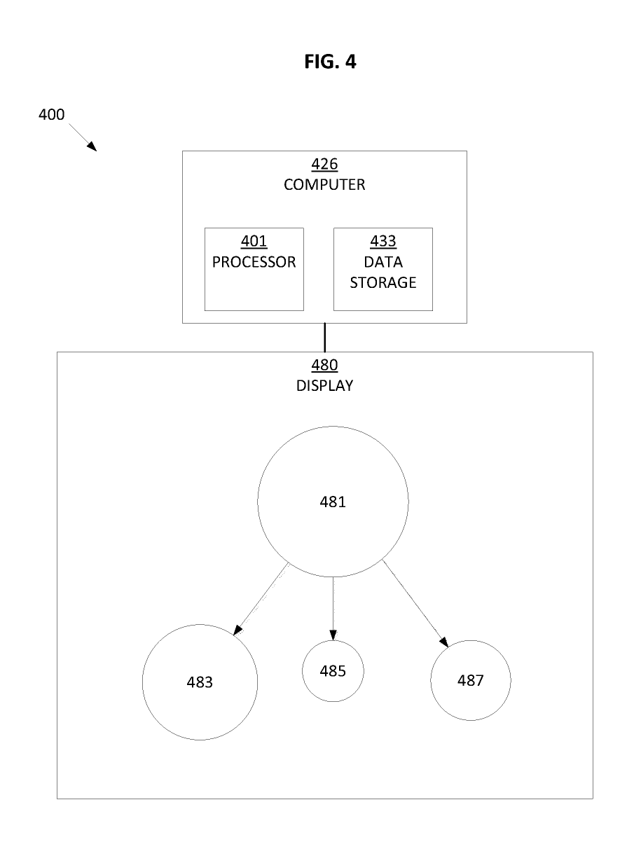

FIG. 4 is a block diagram of an information display system 400 for displaying work time data. Display 400 includes computer display 480 and computer system 426 having processor 401 and data storage 433. Data storage 433 is configured to hold a list of task identifiers and a time estimate associated with each task identifier. Computer system 426 is configured to automatically measure an actual work time associated with each task identifier stored in the data storage as a user works on computer system 426. Computer display 480 shows a graphic object for each task identifier stored in the data storage. The graphic object has first property which is a function of the time estimate associated with its task identifier, and a second property which is a function of the measured actual work time associated with the task identifier. In one form of the display system, the first property is a size proportional to the time estimate, and the second property is a color that is a function of the difference of the measured work time and the time estimate for a given task. For example, the graphic object may be a circle with a radius proportional to the time estimate which is color green when the measured time is less than the time estimate and is colored red when the measured time is greater than the time estimate.

The functions may include a task due date, a task budget, a worker fee rate, and/or other similar information.

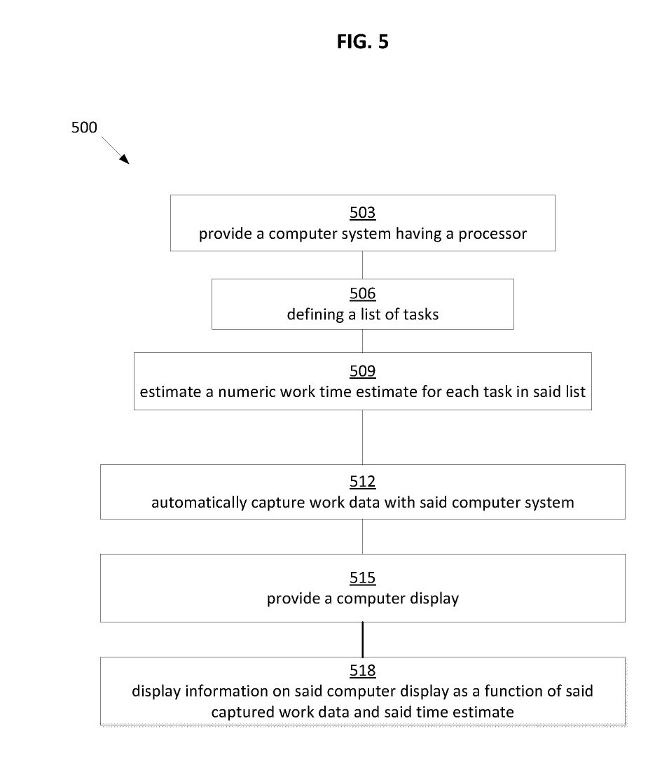

FIG. 5 is a flowchart for a method 500 of displaying work time information. Method 500 begins with step 503 of providing a computer system having a processor. The computer system may be any basic computer system, such as a desktop computer, notebook computer, phone, smartphone, personal data assistant, watch, tablet computer, or any other similar computer. The processor may be implemented as a microprocessor, microcontroller, CPU, FPGA, ASIC, programmable logic device, or other similar controller. Step 506 includes defining a list of tasks. Defining a list of tasks may include providing a task identifier, such as a task name, for each task. Step 509 includes estimating a work time estimate for each task in the list of tasks. The work time estimate is simple a number representing a unit of work time, such as work hours that is needed to complete a task. In step 512, work data is automatically captured with the provided computer system. Work data generally includes any information relating to a user's interaction with the computer, and may include human interface device information such as activity on a keyboard, mouse, touchpad, touchscreen, keypad, accelerometer, gyroscope, microphone, speaker, camera, and/or graphical display information including screenshots. The work data may also include location data, phone system data, network data such as IP addresses, phone numbers, or URLs, active/open window names, active/background process names, active/background application names, open/saved filenames, and/or form data. The work data may also include data that is extracted from other data, such as text strings extracted from screenshots through optical character recognition, or keyboard activity levels from keystroke data.

Step 515 includes providing a computer display. The computer display is a computer monitor, light display, projector, and/or any other similar dynamic display. Step 518 is displaying information on the computer display as a function of the captured work data and the time estimate. The display may include representing each task as a graphical object with properties which are functions of the captured work data and the time estimate. For example, the graphical object may be a circle with a radius proportional to the time estimate which is color green when the measured time is less than the time estimate and is colored red when the measured time is greater than the time estimate. The functions may further include a task due date, a task budget, a worker fee rate, and/or other similar information.

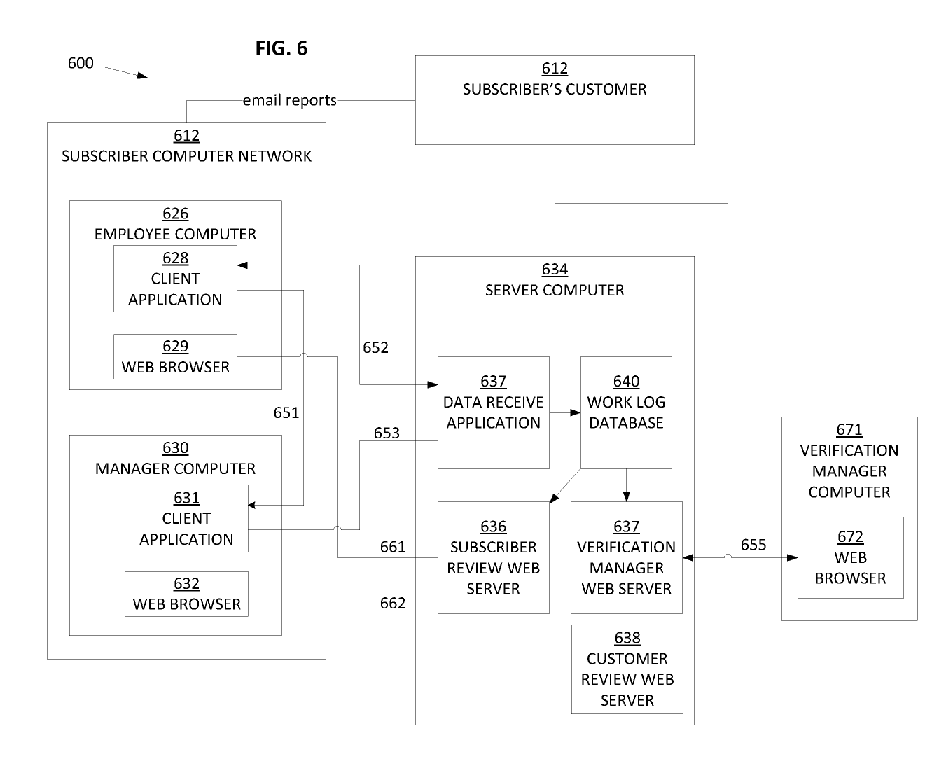

FIG. 6 is a block diagram of a second embodiment system 600 for automated work logging. System 600 generally includes server computer subscriber computer network 612, server computer 634, and verification manager computer 671. Subscriber computer network 612 generally includes one or more computers, such as employee computer 626 and manager computer 630. Employee computer 626 is either a computer, such as a PC, or a mobile device, such as a iOS smartphone. Manager computer 630 is generally an equivalent type of computer to employee computer 626. Computers 626 and 630 are linked on the subscriber computer network 612 through an Ethernet LAN which is connected to an external Internet, or other similar network configuration.

On employee computer 626 and manager computer 630 are installed client application installations 628 and 631. Client application installations 628 and 631 are installations of the same client application. Client application 628 automatically captures computer usage data, classifies and tags the computer usage data into predetermined or automatically generated tasks, and transmits 652 a work log of the tagged computer usage data to server 634.

Server 634 has data receive application 637 which receives classified computer usage data from one or more client applications, such as client applications 628 and 631. Server 634 has work log database 640 for storing tagged computer usage data received by receive application 637. Server 634 also has multiple different interfaces for users to view and change information in work log data storage 640, including interfaces 636, 637, and 638. Subscriber review interface 636 is for allowing subscriber entities to review and edit information in work log data storage 640 associated with subscriber 612. Subscriber review interface 136 may be implemented as a web server, and may be accessed via a web browser on any networked computer, such as web browser 629 on subscriber computer 626. Server 634 also has verification manager interface 637, which allows a verification manager working on verification computer 671 to verify data in work log storage 640. Verification manager interface 637 may also be implemented as a web server which provides a subset 655 of the computer usage data stored in work log data storage to a verification manager computer 671 through web browser 672. The verification manager interface 637 provides a verification manager the ability to either mark the reviewed work log and computer usage data as either correct or suspect. Marking the data as suspect generates an alert. The alert may be a message sent to a subscriber entity, such as an employee, asking the employee to double check the correctness of the suspect work log. The employee may then either edit the suspect work log, or may assert that the suspect work log is indeed correct. If the worker asserts that the suspect work log is correct, server 634 may generate a second level alert, which may be sent to the worker's manager, or other party.

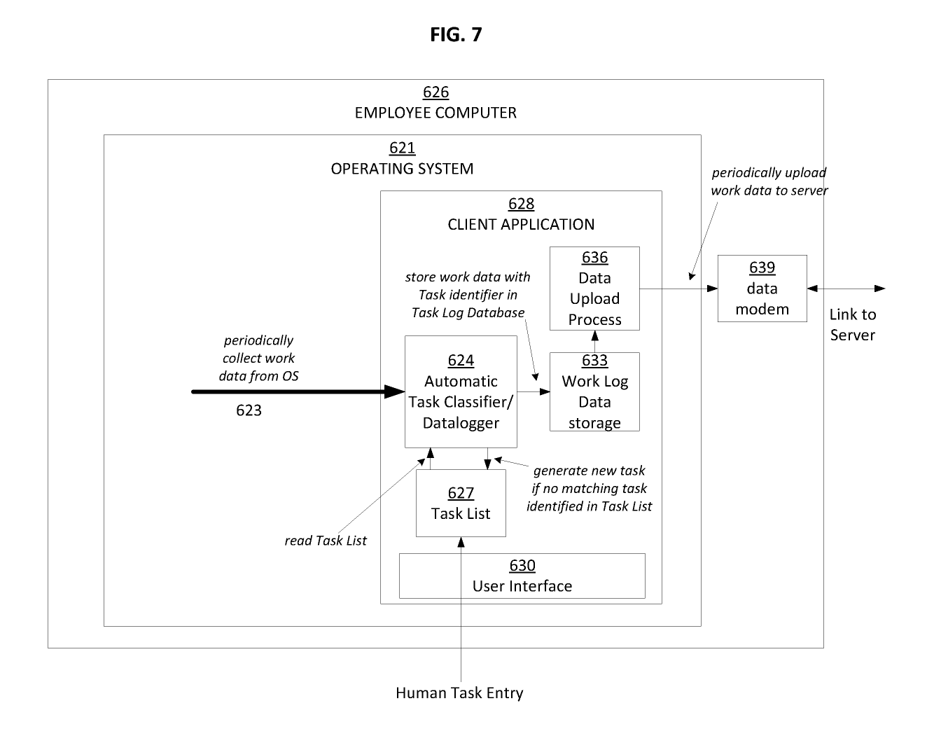

FIG. 7 is a block diagram of employee computer 626 showing the details of client application 628. As shown in FIG. 7, employee computer 626 includes operating system 621 and installed client application 628. Client application 628 includes automatic task classifier/datalogger module 624, task list 627, user interface 630, data upload process 636, work log data storage 633, and data modem 639.

User interface 630 is a graphical user interface which provides a user the ability to start/stop the automatic data logging/tracking system as well as provides the ability for a user to manually generate task list entries. The task list is a list of tasks, each task including a task name and one or more task identifier attributes. The task identifier attributes are properties automatically created by automatic task classifier 627 which allow the task classifier to match computer usage data 623 to tasks in task list 627. In addition to manual task entry by a user through user interface 630, a task list may be downloaded from server computer 634. Further, new entries may be generated in task list 627 by automatic task classifier 624 as will be described.

Automatic classifier/datalogger 624 periodically collects computer usage data 623 from operating system 621. Data is gathered at a specified time interval of every thirty seconds while the operating system indicates that the computer is not idle. If the computer is idle, i.e. no user activity and/or no display change, data is not gathered. However, the specific intervals and data gathering characteristics may be varied easily through configuration changes. As data 623 is captured by automatic task classifier 624, classifier 624 attempts to match the data with a specific task in task list 627. More specifically, classifier 624 attempts to match the data to the task identifiers associated with each task in task list 627. If no matching task can be identified, classifier 624 creates a new matching task in task list 627. Automatic task classifier 624 then stores the matched data into work log data storage 633. The data stored in work log data storage 633 is tagged with the matching task, and also a total work time associated with each task is maintained. The work time is calculated using a timestamp associated with the computer usage data 623.

Data upload process 636 will periodically transmit data from work log data storage 633 to server 634 through data modem 639. This transmission will only occur when a network link can be established between data modem 639 and server 634. Data upload process 636 keeps track of what data in work log data storage has been uploaded to server 634, such that is a long period of time goes by without a network link between modem 639 and server 634, all untransmitted data will uploaded to server 634 once a network connection is available.

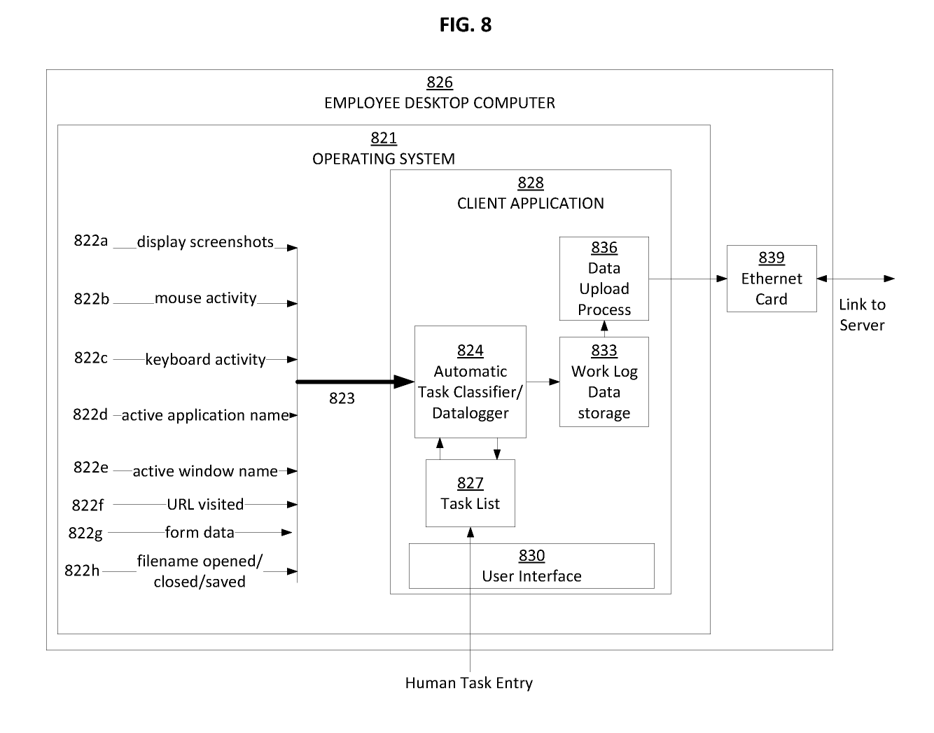

FIG. 8 provides a specific version of employee computer 626 in which employee computer 626 is a desktop computer 826. Desktop computer 826 is an apple computer running MacOS operating system 821. However, alternative computer types, such as PCs, UNIX/LINUX computers, or other similar computers may be used as well. Client application 828 collects computer usage data comprising: display screenshots 822a, mouse activity 822b, keyboard activity 822c, active/open application names 822d, active/open window names 822e, URLs or IP addresses visited 822f, form data 822g, and filename opened/closed/saved data 822h.

Automatic task classifier 824 captures this data every thirty seconds. Classifier 824 further processes the captured data to extract further information. Classifier 824 generates a subset of the display screenshots in which only a wireframe of the windows are shown in the screenshot, including the window names. Additionally, optical character recognition is performed on the screenshots on specially named windows in order to extract task identifier information, such as an account name.

A matching algorithm is then run on automatic task classifier 824 matching the data to a specific task in task list 827. This matched data is stored in work log data storage 833, and uploaded by data upload process 836 as described in the previous section.

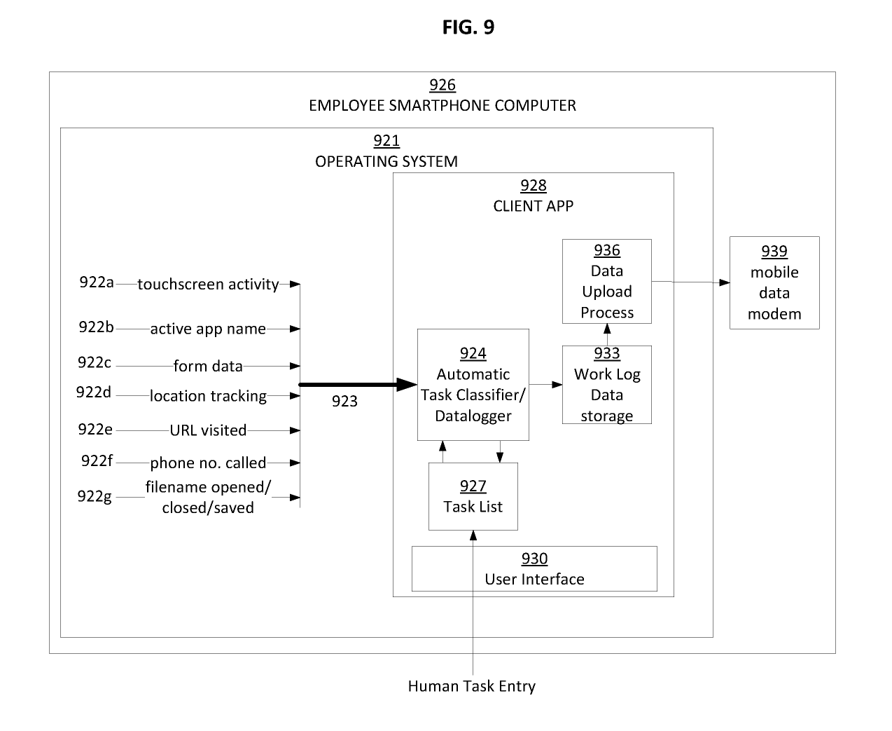

FIG. 9 provides a specific version of employee computer 626 in which employee computer 626 is a smartphone computer 926. Smartphone 826 is an apple iphone running iOS operating system 921. However, alternative smartphone types, such as android phones, blackberry phones, tablet computers, or other similar computers may be used as well. Client app 928 is installed onto smartphone 926 by downloading either through a centralized app store, such as Apple App Store, or is provided directly from a separate provider. Client application 928 collects smartphone usage data comprising: touchscreen activity 922a, active app name 922b, form data 922c, location tracking data 922d, URLs and IP addresses visited through a browser 922e, phone numbers called and received 922f, and filename opened/closed/saved data 922h.

Automatic task classifier 924 captures this data every as a function of operating system triggers.

A matching algorithm is then run on automatic task classifier 924 matching the data to a specific task in task list 927. This matched data is stored in work log data storage 933, and uploaded by data upload process 936 through mobile data modem 939, similar to how upload process 836 operates.

In alternative embodiments, a display system may be implemented in which Gantt charts or other similar project management charts are populated or modified as a function of the computer usage data. Such Gantt charts would have the increased utility of having real-time project data gathered by the computer system. In other embodiments, the computer usage data may be augmented to include audio recordings of phone calls. The audio recordings can be analyzed by performing a speech to text conversion. The converted text may be used to classify tasks and or identify whether work was being performed or not. In additional embodiments, a system for monitoring an employees work performance and/or fatigue level may be included. The work performance monitoring may include incentives and or punishments for reinforcing or inhibiting particular behavior. For example, incentives may be monetary awards, or increased vacation time. Disincentives may be warnings and or on screen alerts.

The disclosed embodiments resulted in a number of surprising advantages. The gathered work log data represented extremely precise work log measurements. The productivity of workers was found to increase markedly. The overall work quality also improved. This translated into increased efficiency for subscribers and customer projects. The precise work log measurements allowed for a high degree of precision in customer settlements. The higher level of confidence in ability to track work time provides increased opportunity to allow telecommuting and flexible work times, which result in greater employee satisfaction.

Therefore, while the presently-preferred form of the method and system for automated work logging and incident management has been shown and described, and several modifications discussed, persons skilled in this art will readily appreciate that various additional changes may be made without departing from the scope of the invention.

1. A computer system for automated work logging comprising:
a processor;
an automatic data capture module for capturing computer usage data (123);
a task list (127) having one or more tasks;
a task matching unit (124), said task matching unit configured and arranged to match a task in said task list to said computer usage data; and
a work log data storage (133) for storing matched computer usage data.

2. The computer system as set forth in claim 1, wherein said automatic data capture module is configured and arranged to capture data using an event based algorithm.

3. The computer system as set forth in claim 1, and further comprising a data review module (136) for allowing a data reviewer (17) to view a contents of said work log data storage.

4. The computer system as set forth in claim 1, wherein said automatic task classifier is configured and arranged to insert (103) a new task in said task list when a task matching said computer usage data is not in said task list.

5. A method (200) of monitoring usage by a computer system user of a computer system comprising the steps of:
providing (203) a computer system (100) having a processor (101) and a task list, said task list reflecting a plurality of user tasks which may be performed by a computer system user;
capturing (206) from said processor (101) computer usage data (123) corresponding to user tasks actually performed on said computer system by said computer system user;
automatically comparing said computer usage data (123) to said task list (127) to determine whether said computer usage data (123) matches a user task in said task list;
if no match is found in said task list for said computer usage data, automatically generating a first new user task obtained as a function of said captured computer usage data, and adding the first new user task to said task list (127);
if a match is found in said task list for said computer usage data, automatically tagging (212) said computer usage data with said matched task; then storing (215) said tagged computer usage data in a data storage (133); and generating (218) work log data of a total amount of time spent on each user task within said task list based upon said tagged computer usage data.

6. The method of monitoring a computer system as set forth in claim 5, wherein said computer usage data comprises display screenshots, mouse activity, keyboard activity, visible window names, or URLs visited by a browser.

7. The method as set forth in claim 5, wherein said computer usage data comprises a wireframe screenshot and display window metadata.

8. The method of monitoring a computer system as set forth in claim 5, wherein said computer usage data comprises a geographic location, a phone number, a camera image data, or user interface input.

9. The method of monitoring a computer system as set forth in claim 5 and further comprising:
analyzing said computer usage data to verify that said data represents valid work.

10. The method of monitoring a computer system as set forth in claim 9, wherein
said step of analyzing is performed by a computer algorithm.

11. The method of monitoring a computer system as set forth in claim 9, wherein said step of analyzing is performed by human analyzer.

12. The method of monitoring a computer system as set forth in claim 9, wherein said step of analyzing comprises the step of reviewing keyboard activity, mouse activity, display screenshots, window metadata, and network data.

13. (canceled)

14. The method as set forth in claim 5 and further comprising the step of determining whether said computer usage data represents an employee performing within a set of pre-established rules.

15. The method as set forth in claim 14, wherein said pre-established rules include parameters for a core work time, a total work time, a work time by PC, a work time for a given location, a work time via telephone, a manually added work time amount, a work start time, a work stop time.

16. The method as set forth in claim 5 and further comprising the step of generating reports.

17. The method as set forth in claim 16, wherein said reports are based upon said stored work log data associated with a given employee or task.

18. The method as set forth in claim 5 and further comprising the step of generating an employee performance rating as a function of said computer usage data.

19. The method of monitoring a computer system as set forth in claim 5, wherein said step of comparing comprises the step of comparing said computer usage data to a text string associated with a task in said task list.
